(19) United States
(12) Patent Application Publication
(10) Pub. No.: US 2025/0200557 A1
(43) Pub. Date: Jun. 19, 2025

(54) SYSTEMS AND METHODS FOR REFUNDING PREFUNDED VIRTUAL CARDS

(71) Applicant: Capital One Services, LLC, McLean, VA (US)

(72) Inventors: Daniel Polinsky, Falls Church, VA (US); Stephanie Hardwick, Falls Church, VA (US); Sulbigar Shanawaz, Herndon, VA (US); Arthur Han, Fairfax, VA (US); Shruthi Musukula, Ashburn, VA (US); Sridhar Davuluri, Aldie, VA (US)

(21) Appl. No.: 18/539,119

(22) Filed: Dec. 13, 2023

(51) Int. Cl. G06Q 20/34; G06Q 20/02; G06Q 20/10

(52) U.S. Cl. CPC G06Q 20/351; G06Q 20/023; G06Q 20/108

(57) ABSTRACT

Disclosed embodiments may include a system for refunding prefunded virtual cards. The system may include determining that a card has expired and has a balance. If the card has a balance, the system may determine if all the transactions have posted. If the transactions have all posted, the system may issue a refund. If the transactions have not all posted, the system may generate an expiration period. During the expiration period, if all the transactions post, the system may issue a refund before the end of the expiration period. If a transaction does not post, the system issues a refund only after the end of the expiration period.

### FIELD

The disclosed technology relates to systems and methods for refunding prefunded virtual cards. Specifically, this disclosed technology relates to automatically determining if a prefunded virtual card balance is eligible to be refunded based on a number of factors.

### BACKGROUND

In traditional commercial credit lending systems, a bank may grant a commercial customer a line of credit for a credit card. Under the agreement of the credit card, a commercial customer may make charges to make purchases and pay vendors up to a credit limit. At the end of a time period when the charges come due, the commercial customer has to pay the bank back for the amount charged on the account.

### SUMMARY

Disclosed embodiments may include a system for refunding prefunded virtual cards. The system may include one or more processors, and memory in communication with the one or more processors and storing instructions that, when executed by the one or more processors, are configured to cause the system to refund prefunded virtual cards. The system may receive status information regarding a prefunded virtual card. The system may determine, from the status information, that the prefunded virtual card has expired and has a balance. In response to determining that the prefunded virtual card has expired and has the balance, the system may determine whether the prefunded virtual card is associated with unposted transactions. In response to determining that the prefunded virtual card is not associated with unposted transactions, the system may refund the balance of the prefunded virtual card to an account. In response to determining that the prefunded virtual card is associated with unposted transactions, the system may retrieve an expiration period starting from an expiration date of the prefunded virtual card. The system may also iteratively determine whether all of the unposted transactions have posted until the expiration period has expired or all the unposted transactions have posted. Upon determining that all of the unposted transactions have posted during the expiration period, the system may also refund the balance of the prefunded virtual card to the account before expiration of the expiration period. Upon determining that the expiration period has expired, the system may refund the balance of the prefunded virtual card to the account after expiration of the expiration period.

Disclosed embodiments may include a system for refunding prefunded virtual cards. The system may include one or more processors, and memory in communication with the one or more processors and storing instructions that, when executed by the one or more processors, are configured to cause the system to refund prefunded virtual cards. The system may receive status information regarding a prefunded virtual card. The system may also receive a cancellation request associated with the prefunded virtual card. Additionally, the system may determine, from the status information and the cancelation request, that the prefunded virtual card has been cancelled and has a balance. Furthermore, the system may generate a first graphical user interface displaying a first message that the prefunded virtual card is cancelled and giving a user an option to request a refund. In addition, the system may transmit the first graphical user interface to a user device for display. Furthermore, the system may receive, from the first graphical user interface on the user device, a request for the refund of the balance of the prefunded virtual card. The system may determine whether an initial transfer has cleared. In response to determining that the initial transfer has cleared, the system may refund the balance of the prefunded virtual card to an account. In response to determining that the initial transfer has not cleared, the system may generate a second graphical user interface displaying a second message that the refund may be delayed, transmit the second graphical user interface to the user device for display, and upon the clearing of the initial transfer, refund the balance of the prefunded virtual card to the account.

Disclosed embodiments may include a system for refunding prefunded virtual cards. The system may include one or more processors, and memory in communication with the one or more processors and storing instructions that, when executed by the one or more processors, are configured to cause the system to refund of prefunded virtual cards. The system may receive status information regarding a prefunded virtual card. The system may also determine, from the status information, that the prefunded virtual card has expired and has a balance. Furthermore, the system may generate a first graphical user interface displaying the status information, and that the prefunded virtual card has expired and has the balance. Additionally, the system may transmit, to a user device, the first graphical user interface for display. In response to determining that the prefunded virtual card has expired and has the balance, the system may determine whether all the prefunded virtual card is associated with unposted transactions. In response to determining the prefunded virtual card not associated with unposted transactions, the system may refund the balance of the prefunded virtual card to an account, generate a second graphical user interface displaying a first message that the prefunded virtual card is being refunded, and transmit, to the user device, the second graphical user interface for display. In response to determining that the prefunded virtual card is associated with unposted transactions, the system may retrieve an expiration period starting from an expiration date of the prefunded virtual card and iteratively determine whether all of the unposted transactions have posted until the expiration period has expired or all the unposted transactions have posted. Upon determining that all of the unposted transactions have posted during the expiration period, the system may refund the balance of the prefunded virtual card to the account before expiration of the expiration period. Upon determining the expiration period has expired, the system may refund the balance of the prefunded virtual card to the account after expiration of the expiration period. The system may also generate a third graphical user interface displaying the first message that the prefunded virtual card is being refunded and transmit, to the user device, the third graphical user interface for display.

Disclosed embodiments may include a system for refunding prefunded virtual cards. The system may include one or more processors, and memory in communication with the one or more processors and storing instructions that, when executed by the one or more processors, are configured to cause the system to refund prefunded virtual cards. The system may receive status information regarding a prefunded virtual card. The system may also receive a cancellation request associated with the prefunded virtual card. Additionally, the system may determine, from the status information and the cancelation request, that the prefunded virtual card has been cancelled and has a balance. Furthermore, the system may generate a first graphical user interface displaying a first message that the prefunded virtual card is cancelled and indicating the balance is being refunded to the account. In addition, the system may transmit the first graphical user interface to a user device for display. The system may determine whether an initial transfer has cleared. In response to determining that the initial transfer has cleared, the system may refund the balance of the prefunded virtual card to an account. In response to determining that the initial transfer has not cleared, the system may generate a second graphical user interface displaying a second message that the refund may be delayed, transmit the second graphical user interface to the user device for display, and upon the clearing of the initial transfer, refund the balance of the prefunded virtual card to the account.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIGS. 1A and 1B are flow diagrams illustrating exemplary methods for refunding prefunded virtual cards in accordance with certain embodiments of the disclosed technology.

FIGS. 2A and 2B are flow diagrams illustrating exemplary methods for refunding prefunded virtual cards in accordance with certain embodiments of the disclosed technology.

FIG. 3 is block diagram of an example balance refund system used to provide refunding prefunded virtual cards, according to an example implementation of the disclosed technology.

FIG. 4 is block diagram of an example system that may be used to provide refunding prefunded virtual cards, according to an example implementation of the disclosed technology.

FIG. 5 is an example graphical user interface used to refund prefunded virtual cards, according to an example implementation of the disclosed technology.

FIGS. 6A-F are example graphical user interfaces used to refund prefunded virtual cards, according to an example implementation of the disclosed technology.

FIGS. 7A-C are example graphical user interfaces used to refund prefunded virtual cards, according to an example implementation of the disclosed technology.

FIG. 8 is an example graphical user interface used to refund prefunded virtual cards, according to an example implementation of the disclosed technology.

### DETAILED DESCRIPTION

Prefunded virtual cards are a modern alternative to commercial banking credit lines. With prefunded virtual cards, when the commercial customer requests to create a new virtual card for a specific dollar amount, the bank initiates an ACH payment to fund a new card. The customer can begin spending with the new card, while the bank extends credit for that card for the specified dollar amount and carries float risk during the 2-3 business days the ACH payment is in transit and deposited. The bank sets a daily limit for the total dollar amount of virtual cards that the customer can create, and that daily limit is reset every day. New prefunded virtual cards cannot exceed the dollar amount of the remaining daily limit each day.

Accordingly, sometimes a commercial customer may not use the complete balance of a prefunded virtual card before it expires, or a commercial customer may cancel a prefunded virtual card with a balance still on the card. Historically, balances from prefunded virtual cards in these situations could not be refunded automatically due to potential risks to the bank, and security and technical limitations. By default, in traditional systems, the bank stores these unspent balances in a separate account (“unspent funds account”) controlled by the client, and the funds in that account are used to fund future prepaid virtual cards. If the client wishes to receive those unspent funds back to their originating funding account, instead of using it to fund new cards, the customer must call a customer service representative to initiate a refund to the originating funding account. This takes several days, requires active participation by the customer, and prevents the customer from instantly using the money from the cancelled prefunded virtual card elsewhere.

In addition, customer service must instruct the client to not create any new virtual cards for several days while this customer service is processing the refund. This is because the refund amount is drawn from the unspent funds account, and the account balance may not be adjusted until the final step when the refund ACH is sent to the client. If the customer does create a new virtual card during the several days customer service needs to process the refund, the new card would be funded by the unspent funds account, and sending a refund would “double spend” the money in the unspent funds account. This waiting period inconveniences the customer, who may need to create new virtual cards to make urgent payments. As such, customers want prefunded virtual cards that automatically refund unspent funds to the funding account without storing money in an unspent funds account and banks need to minimize risk and security considerations.

Accordingly, there is a need for improved systems and methods for refunding prefunded virtual cards. Embodiments of the present disclosure are directed to this and other considerations.

A prefunded virtual card is a virtual credit card that has a limit related to how much the customer pays to the bank in advance (e.g., if the customer pays the bank $10,000 for the prefunded virtual card, then the limit of the card is $10,000 and the card balance is reduced as the customer uses the card). A prefunded virtual card customer also has a daily spend limit for their account that limits the total dollar amount of prefunded virtual cards the customer can create in one calendar day (e.g., if the customer's account has a daily spend limit of $100,000, the customer can create one or many cards summing up to $100,000 each day, and that daily limit resets the following day). This is unlike normal virtual credit cards where the bank extends the customer a credit limit and then the customer pays back the bank at the end of a time period, and, accordingly, creates unique problems for both the bank and the customer/user.

Typically, when a payment card is used (whether that be a virtual credit card or credit card), the transaction settlement process begins when the user first authorizes the vendor to initiate the payment (“the swipe”). The transaction is visible on the account at this point as a “pending transaction.” Later, when the transaction settlement process is completed by the vendor, the charge posts to the user's credit card account and is visible on the account as a completed transaction (“the post”). Varying amounts of time can exist between the ‘swipe’ and the ‘post’. In the case of a prefunded virtual card, the bank needs to verify that all of the transactions have ‘posted’ and the transaction settlement process has completed before starting to refund the customer the balance in the prefunded virtual card account. If the bank refunded the money to the customer before the transaction settlement process had completed or ‘posted’ for all transactions, the bank may over-refund the account, which would require the bank to have to ask the customer to pay back the overpaid funds or the bank would have to provide the funds on its own. This creates a problem for both the customer, who would like the funds to be refunded as quickly as possible, and the bank, which wants to prevent refund overpayment.

Similar to wanting to prevent excess refunding when before a transaction has posted, another issue can arise when a card is cancelled. Funding for prefunded virtual cards is typically provided by automated clearing house (“ACH”) transfer, which typically takes 3 days. However, upon the start of the transfer, the prefunded virtual card is created for immediate use in the amount related to the pending ACH transfer. If the user attempts to cancel the card and start the refund process before the funding ACH transfer is complete, the bank may be stuck in a problematic situation and may have insufficient funds in the account to process the refund because the original fund transfer had not yet completed.

Furthermore, because it may take 3 business days to detect from the Federal Reserve if a funding ACH from a client is “returned” (e.g., the funding ACH payment fails and does not deposit), a bad actor could defraud the bank by creating cards up to the daily spend limit for 3 days, knowing the funding ACH would fail, and spending the entire balance each day. On the 3rd day, the bank would detect a returned ACH and block the customer's account from spending. A second way a bad actor could defraud the bank would be by creating cards up to the daily spend limit for 3 days and immediately canceling them or changing their expiration dates to the next day, triggering automated refunds each day. The bad actor could therefore take advantage of the delay in processing ACHs to receive refunds for cards that would never be funded. The disclosed embodiments are designed to prevent this and other issues.

The methods described may be applied to credit or debit cards or other types of accounts in addition to prefunded virtual cards. However, the problem with reconciling balances with prefunded virtual cards is not typically a problem found with other types of cards because the user does not pay in advance.

Examples of the present disclosure related to systems and methods for refunding prefunded virtual cards. More particularly, the disclosed technology relates to determining whether the prefunded virtual card has met certain criteria. The systems and methods described herein utilize, in some instances, graphical user interfaces, which are necessarily rooted in computers and technology. Graphical user interfaces are a computer technology that allow for user interaction with computers through touch, pointing devices, or other means. The present disclosure details methods for refunding prefunded virtual cards in some cases requiring graphical user interfaces. This, in some examples, may involve using prefunded virtual card data to dynamically change the graphical user interface to show the user the progress of prefunded virtual card refunds and provide the user with a method by which to request a refund or cancellation of a prefunded virtual card. Using a graphical user interface in this way may allow the system to keep the user abreast of refund progress and complete a refund process automatically without requiring human intervention. This is a clear advantage and improvement over prior technologies that required a user to call and request a refund, which is a slow and convoluted process taking a significant amount of time. The present disclosure solves this problem by automating the refund process by determining if the account and prefunded virtual card meets certain criteria.

Furthermore, examples of the present disclosure may also improve the speed with which computers can process prefunded virtual card refunds. Previously, refunding prefunded virtual cards required manual intervention and could not be processed by computers without reprogramming for individual refunds. Computers formerly lacked the ability to determine if the necessary criteria were present to allow the refund to occur while also guaranteeing that prefunded virtual card account balances would be refunded accurately and at an appropriate time after funding had completed and all transactions had posted. Overall, the systems and methods disclosed have significant practical applications in the prefunded virtual card field because of the noteworthy improvements of the processing refunds for prefunded virtual cards, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

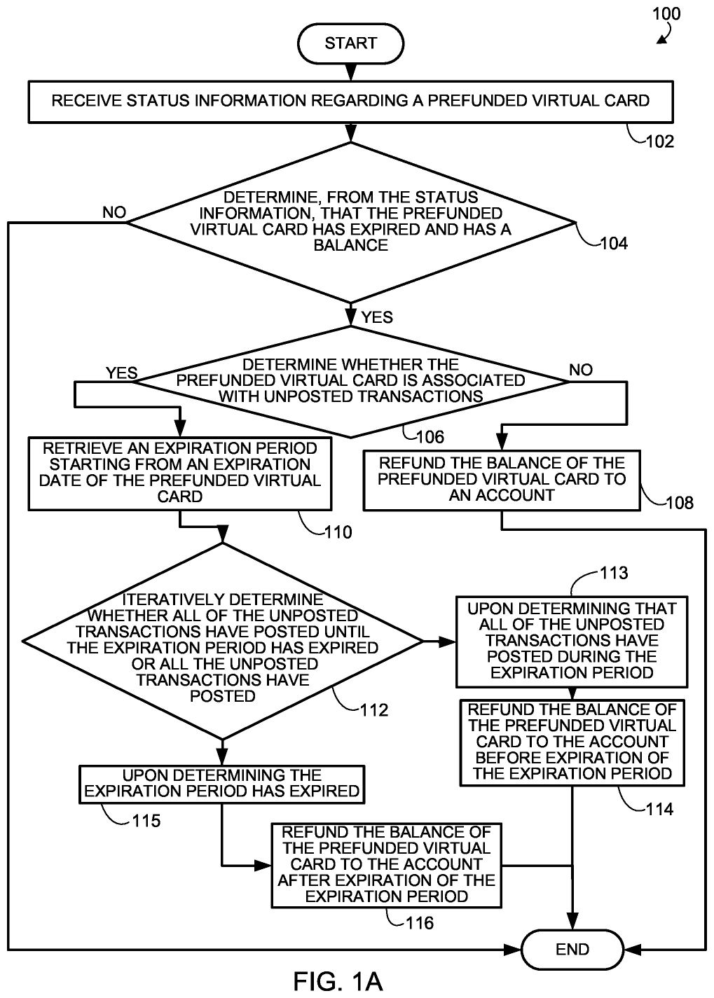

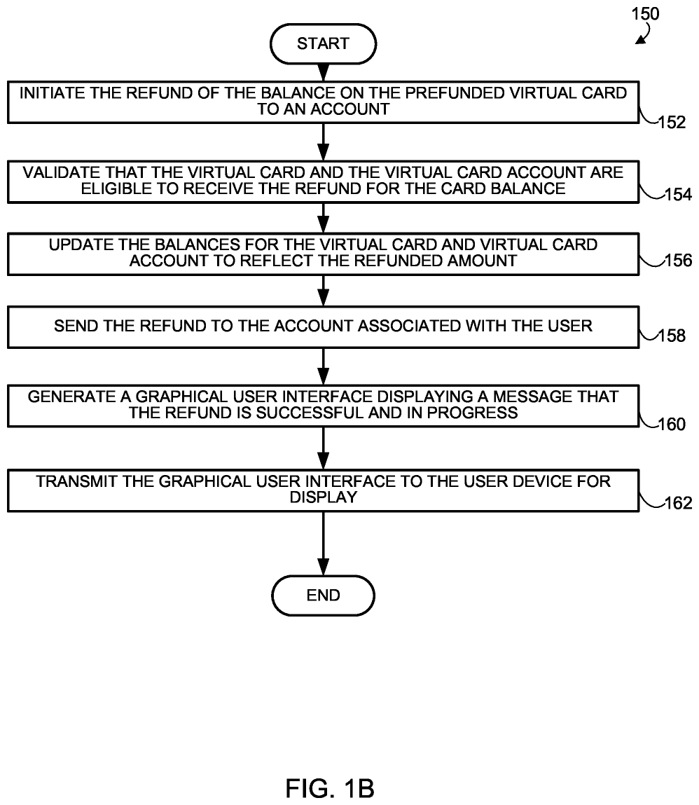

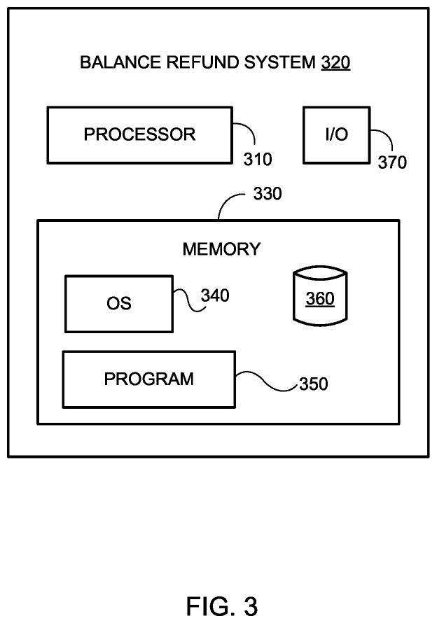

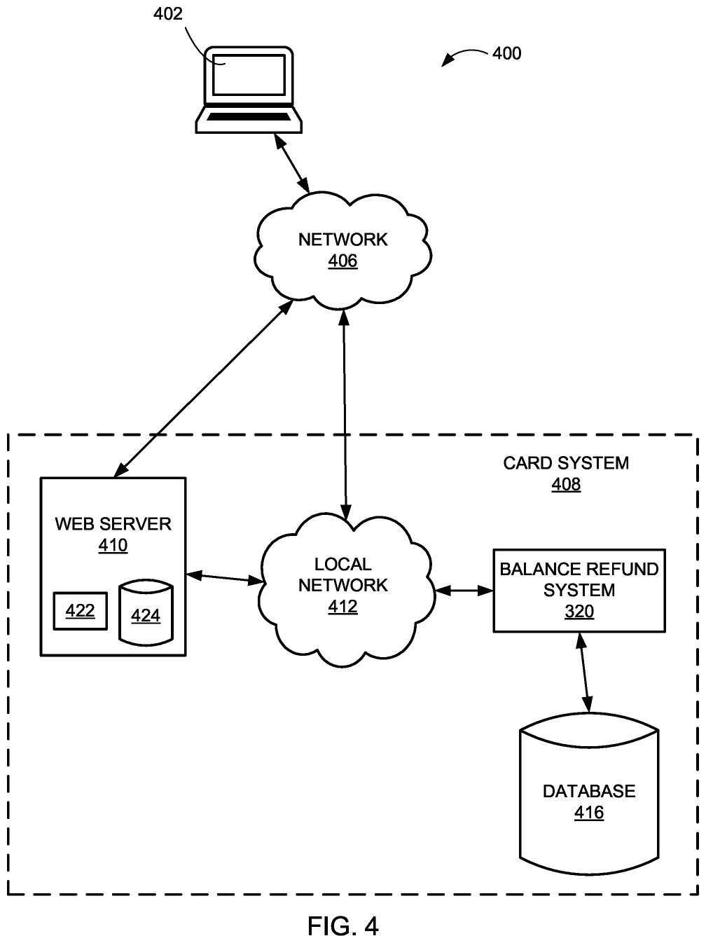

FIG. 1A is a flow diagram illustrating an exemplary method 100 for refunding prefunded virtual cards, in accordance with certain embodiments of the disclosed technology. The steps of method 100 may be performed by one or more components of the system 400 (e.g., balance refund system 320 or web server 410 of card system 408 or user device 402), as described in more detail with respect to FIGS. 3 and 4.

In block 102, the balance refund system 320 may receive status information regarding a prefunded virtual card. The status information may include information about the card, such as the original balance and any balance increases or decreases, such as those caused by transactions, the time or date the card was created, the time or date the card expires, extensions of time to use the card, and the card number and/or CVV code. Alternatively, the balance refund system 320 may also retrieve information about the prefunded virtual card.

In block 104, the balance refund system 320 may determine, from the status information, that the prefunded virtual card has expired and has a balance. From the status information provided in block 102, the balance refund system 320 determines if the card has expired. The balance refund system 320 may complete this by comparing the expiration date and/or time of the virtual card to the current date and/or time. The balance refund system 320 may determine if the user requested any extensions of time for the virtual card. Alternatively, the balance refund system 320 may receive an indication that the car has expired (e.g., a Boolean variable indicating if a card has expired with a “true” indication). The balance refund system 320 also determines if the virtual card has a balance. This may include the balance refund system 320 adding up all of the transactions and comparing the value to the original amount of funds that were used to create the card. Alternatively, the balance refund system 320 may receive an indication that the card contains a balance and/or the amount of the balance. If the balance refund system 320 determines that the card has not expired and/or the card does not have a balance, then the process ends, as the balance does not need to be refunded to the customer at this time. If there is a balance and the card has expired, then the process continues to block 106.

The balance refund system 320 may provide information and alerts to the user regarding the prefunded virtual card. The balance refund system 320 may generate a graphical user interface that displays the status information of the prefunded virtual card, such as the current balance, the original funding amount, and the source funding account. The graphical user interface may also display the output from the balance refund system 320 regarding if the prefunded virtual card has expired and/or if the prefunded virtual card has a balance. The balance refund system 320 may transmit the graphical user interface to a user device, such as a smartphone or computer, for display.

The graphical user interface may be interactive and may show dynamic, live information about the prefunded virtual card as determined by the balance refund system 320. For example, if the prefunded virtual card is expired, the graphical user interface may show that the prefunded virtual card is expired. When the card is expired, an option may become available to the user that allows a user to begin the refund process (e.g., a button becomes visible that the user can click or touch to start the refund). Alternatively, the graphical user interface may show that the card is expired and show the status of the refund automatically. Additionally, the graphical user interface may provide a method for the user to prevent the automatic refund process from occurring. The status of the refund displayed in the graphical user interface may relate directly to the different steps shown in FIG. 1A.

In block 106, the balance refund system 320 may determine whether the prefunded virtual card is associated with unposted transactions (e.g., unsettled authorizations). Transactions that have posted have completed the transaction settlement process and are complete. In the case of a prefunded virtual card, transactions that have posted have been debited from the overall balance. The balance refund system 320 may determine if any transactions exist that have started the transaction settlement process (e.g., have been “swiped”), but have not been marked as complete. In the case that a transaction has been swiped, but a post has not occurred, the balance refund system 320 may consider the transaction as posted if a certain amount of time has passed since the swipe. If all the transactions associated with the expired prefunded virtual card have been posted, then the balance refund system 320 can follow the path to block 108. This allows the user to get a refund as quickly as possible if all the transactions have posted, as there is no chance that a later transaction could come through and leave the bank responsible for the funds. If the all the transactions associated with the expired prefunded virtual cand have not been posted, then the balance refund system 320 can follow the path to block 110.

In block 108, the balance refund system 320 may, in response to determining that the prefunded virtual card is not associated with unposted transactions, refund the balance of the prefunded virtual card to the funding account. This may involve the balance refund system 320 using a database or other means to determine the method by which the prefunded virtual card was funded. Typically, the prefunded virtual card would be funded by an ACH payment made from a banking account (e.g., a checking account or savings account) of the business. From this information, the balance refund system 320 may determine the source of the funds (e.g., account number, routing number, name and other account information). The balance refund system 320 may determine the amount to refund by subtracting the transaction charges to the account from the prefunded amount associated with the account. The remaining balance would indicate the amount to be refunded. Refunds may be sent to the funding account of the user by ACH payment or other methods of fund transfer such as wire transfer or electronic transfer. The prefunded account may be verified by balance refund system 320 or an external service before the refund is executed.

The graphical user interface may provide updates regarding the status of the refund to the user in a dynamic fashion. For example, at the start of the refund process, the graphical user interface may display a message like “Beginning refund” or “Beginning refund for $4557.34.” After block 108 has completed the ACH transfer, the graphical user interface may display a message like “The refund has been completed. Keep an eye out for your funds in your bank account ending in 1234.” or “Refunded.” The graphical user interface may also be able to display a list or history of past refunds and past information about those refunds as completed by balance refund system 320.

In block 110, the balance refund system 320 may, in response to determining that the prefunded virtual card is associated with unposted transactions, retrieve an expiration period starting from an expiration date of the prefunded virtual card. In the case that not all transactions have posted, the balance refund system 320 retrieves a time period in which to wait for the transactions to post. The expiration period (e.g., a settlement expiration period) may be fixed or variable. Fixed time periods may be related to a number of days since the expiration of the prefunded virtual card (e.g., 21 days). Variable expiration periods may be related to the status information provided to the balance refund system 320 about the prefunded virtual card. Variable expiration periods may also be related to the type of transactions that typically occur on the prefunded virtual card, known information about the user of the virtual card, and known information about the merchants or processors of the virtual card. In some embodiments, the balance refund system 320 may generate an expiration period.

The graphical user interface may, upon the generation of an expiration period, display a message to the user that the refund may be delayed. The graphical user interface may display an estimated date of the refund. The estimated date of refund may be based on the expiration period. For example, if the card expired on March 1, the expiration period is 21 days, and the date the user is looking at the graphical user interface is March 10, the graphical user interface may display a message like: “Refund delayed. Refund likely available on March 22.” or “Refund delayed. Refund likely available in 10 days.” Furthermore, the balance refund system 320 may be to predict when the refund will be available based on other factors such as the merchant, and use that information to display a more accurate time prediction to the user on the graphical user interface.

In block 112, the balance refund system 320 may iteratively determine whether all of the unposted transactions have posted until the expiration period has expired or all the unposted transactions have posted. The balance refund system 320 may routinely check to see if the transactions have posted during the expiration period. This check ensures that users receive a refund as early as possible by bypassing the duration of the expiration period if all the transactions post during the expiration period. This step may be repeated continuously on a regular basis (e.g., dynamically, or at fixed intervals, such as daily or hourly). Balance refund system 320 may also be setup to recognize or watch for certain transaction posts, and then respond appropriately. If all the transactions have posted, the balance refund system 320 may continue to block 114. If one or more of the transactions has posted, then the balance refund system 320 may continue to block 116.

The graphical user interface may dynamically update in response to transactions posting during the expiration period. Accordingly, the graphical user interface may switch the status of the refund according to if transactions have posted before the expiration period has ended. For example, if the expiration period was created and the graphical user interface indicated that the refund was “delayed” and 5 days into the expiration period the system determined that the last transaction had posted, then the graphical user interface would change the status to “refund processing.”

In block 113, the balance refund system 320 may determine that all the unposted transactions have posted during the expiration period. In block 114, the balance refund system 320 may refund the balance of the prefunded virtual card to the account before the expiration of the expiration period, as a result of the determination in block 113. This allows the refund to be processed as soon as all transactions have posted, instead of waiting the full duration of the expiration period. For example, if the expiration period is 21 days and the last transaction posts on day 4 of the expiration period, then the refund process begins on day 4. Generally, the refund process of block 114 follows the same procedures as the refund process of block 108 and/or method 150 and is not repeated herein for brevity.

In block 115, the balance refund system 320 may determine that the expiration period has expired. In block 116, the balance refund system 320 may refund the balance of the prefunded virtual card to the account after the expiration of the expiration period, as a result of the determination in block 115. For example, in some cases, transactions will fail to post after an indefinite amount of time. In this scenario, to ensure the proper amount is refunded, the balance refund system 320 needs to wait the full duration of the expiration period. After the full duration of the expiration period, the balance refund system 320 may begin the refund process. Generally, the refund process of block 116 follows the same procedures as the refund process of block 108 and/or method 150 and is not repeated herein for brevity.

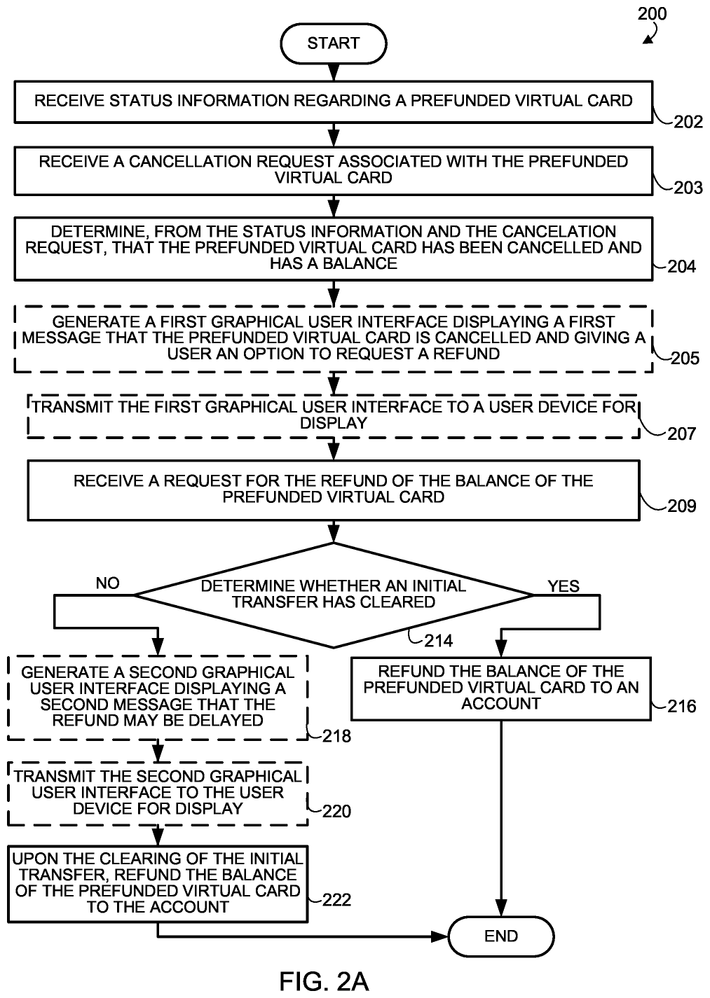

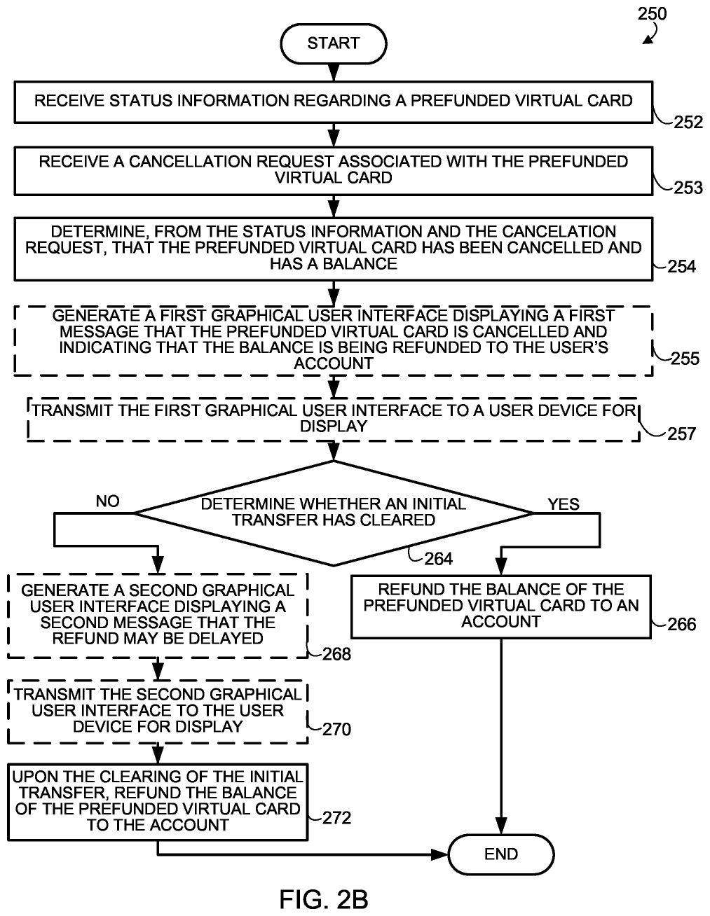

FIG. 1B is a flow diagram illustrating an exemplary method 150 for refunding prefunded virtual cards. The steps of method 150 may be performed by one or more components of the system 400 (e.g., balance refund system 320 or web server 410 of card system 408 or user device 402), as described in more detail with respect to FIGS. 3 and 4. Method 150 may further describe the refund process of block 108, which may be the same or similar to the refund process of blocks 114 and 116. The process may continue from blocks 108, 114, and 116 of FIG. 1A, blocks 216 and 222 of FIG. 2A, or blocks 266 and 272 of FIG. 2B to block 152 of FIG. 1B to complete a refund process.

In block 152, the balance refund system 320 may initiate the refund of the balance on the prefunded virtual card to an account. In block 154, the balance refund system 320 may validate that the virtual card and the virtual card account are eligible to receive the refund for the card balance. In block 156, the balance refund system 320, balance refund system 320 may update the balances for the virtual card and virtual card account to reflect the refunded amount. In block 158, the balance refund system 320 may send the refund to the account associated with the user. The refund may be sent to the user's funding account using an ACH transfer. Block 156 and block 158 may be completed in parallel (e.g., at the same time) after block 154. Block 156 and block 158 may be completed sequentially after block 154. Completing block 156 and block 158 in parallel after block 154 may minimize the delay in sending the refund to the user. In block 160, the balance refund system 320 may generate a graphical user interface displaying a message that the refund was successful and is in progress. This may be accompanied by a graphical indicator of the refund's progress. In block 162, the balance refund system 320 may transmit the graphical user interface to the user device for display. The user may be able to interact with the graphical user interface using the user device.

FIG. 2A is a flow diagram illustrating an exemplary method 200 for refunding prefunded virtual cards that are cancelled, in accordance with certain embodiments of the disclosed technology. The steps of method 200 may be performed by one or more components of the system 400 (e.g., balance refund system 320 or web server 410 of card system 408 or user device 402), as described in more detail with respect to FIGS. 3 and 4.

Method 200 of FIG. 2A is similar to method 100 of FIG. 1A, except that method 200 may not include blocks 106, 110, 112, 113, 114, 115, or 116 of method 100. The descriptions of blocks 202 and 216 in method 200 are similar to the respective descriptions of blocks 102 and 108 of method 100 and are not repeated herein for brevity. Additional blocks 203, 205, 207, 209, 214, 218, 220, and 222 are also described below.

In block 203, the balance refund system 320 may receive a cancellation request associated with the prefunded virtual card. The balance refund system 320 may receive the cancellation request from the user by generating and transmitting a graphical user interface to the user device. The graphical user interface may be similar to that detailed in block 104 and corresponding to FIG. 1A and contain and display information pertaining to the prefunded virtual card. The graphical user interface may have a button that the user may select by clicking or selecting that allows the user to cancel the prefunded virtual card.

In block 204, the balance refund system 320 may determine from the status information and the cancellation request that the prefunded virtual card has been cancelled and has a balance. If the balance refund system 320 receives input from block 203 that the user wants to cancel the card, the balance refund system 320 may determine from the status information if the card has a balance. This process is otherwise similar to block 104 and is not repeated herein for brevity.

In optional block 205, the balance refund system 320 may generate a graphical user interface displaying a message indicating that the prefunded virtual card is canceled and giving the user an option to request a refund. If the balance refund system 320 determines that the canceled card contained a balance, the balance refund system 320 may give the user an option regarding a refund. The graphical user interface may display the amount of the potential refund, the approximate amount of time the refund will take, and other information about the account. The graphical user interface may also provide a button that the user may select by clicking or tapping to initiate the refund. This step, alternatively, may be presented as part of the cancellation request.

In optional block 207, the balance refund system 320 may transmit the graphical user interface to a user device for display. The graphical user interface may be displayed on a user device, such as a smartphone or computer, using a web browser or mobile application.

In block 209, the balance refund system 320 may receive, from the graphical user interface, a request for the refund of the balance of the prefunded virtual card. As a result of the user interacting with and/or selecting the button on the graphical user interface, the balance refund system 320 may receive an indication from the user's device that the user would like to begin the refund process. Once this signal is received, the balance refund system 320 can move to block 214.

In block 214, the balance refund system 320 may determine whether an initial transfer has cleared. The balance refund system 320 may follow a process similar to block 106, as it pertains to ACH payments. The balance refund system 320 may receive a signal or other indication that the initial funding payment of the virtual card is complete. If the initial funding payment is complete, then the balance refund system 320 may follow the path to block 216. If the initial transfer is incomplete, then balance refund system 320 may follow the path to optional block 218. Furthermore, the balance refund system 320 may validate the initial payment before proceeding with the refund, which may comprise the following steps: (1) a determination if the virtual card cancelled properly; (2) business rule validation determining if the card amount is able to be refunded; (3) updating the client balance to reflect the refund; and (4) sending the refund to the funding account via an ACH payment.

In optional block 218, the balance refund system 320 may generate a graphical user interface to display a message to the user that the refund may be delayed. The graphical user interface may be generally similar to the graphical user interface associated with FIG. 1A and may also show other information about the transfer, such as an estimated time that the transfer will be started and account information. Balance refund system 320 may transmit graphical user interfaces via emails, text messages, push notifications, and use in mobile and desktop web browsers.

In optional block 220, the balance refund system 320 may transmit the graphical user interface to a user device for display. The graphical user interface may be displayed on a user device, such as a smartphone or computer, using a web browser or mobile application.

In block 222, the balance refund system 320 may, upon the clearing of the initial transfer, refund the balance of the prefunded virtual card to the account. The balance refund system 320 may determine that the initial transfer has cleared in a similar manner as presented in block 112, as it pertains to electronic transfer payments. Once the initial transfer has cleared, the refund may be processed according to the manner disclosed in block 108 and/or method 150, which is not repeated herein for brevity. Upon the start of the refund, the graphical user interface may be updated accordingly to alert the user of the incoming refund.

FIG. 2B is a flow diagram illustrating an exemplary method 250 for refunding prefunded virtual cards that are cancelled, in accordance with certain embodiments of the disclosed technology. The steps of method 200 may be performed by one or more components of the system 400 (e.g., balance refund system 320 or web server 410 of card system 408 or user device 402), as described in more detail with respect to FIGS. 3 and 4.

Method 250 of FIG. 2B is similar to method 200 of FIG. 2A, except that method 250 may not include block 209 of method 200. The descriptions of blocks 252, 253, 254, 255, 257, 264, 266, 268, 270, and 272 in method 200 are similar to the respective descriptions of blocks 202, 203, 204, 205, 207, 214, 216, 218, 220, and 222 of method 200 and are not repeated herein for brevity. The primary difference of method 250 from method 200 is that in method 250, once the card is cancelled, the system automatically begins the process to refund the card balance to the user's account without user input. In method 200, at block 209, after cancelling the card, the user requests that the balance be returned to the funding account. Accordingly, in method 250, the graphical user interface of blocks 255 and 257 may indicate that the balance is being refunded to the user's funding account. The graphical user interface may indicate the amount being refunded to the user's account.

FIG. 3 is a block diagram of an example balance refund system 320 used to refund prefunded virtual cards according to an example implementation of the disclosed technology. According to some embodiments, the user device 402 and web server 410, as depicted in FIG. 4 and described below, may have a similar structure and components that are similar to those described with respect to balance refund system 320 shown in FIG. 3. As shown, the balance refund system 320 may include a processor 310, an input/output (I/O) device 370, a memory 330 containing an operating system (OS) 340 and a program 350. In certain example implementations, the balance refund system 320 may be a single server or may be configured as a distributed computer system including multiple servers or computers that interoperate to perform one or more of the processes and functionalities associated with the disclosed embodiments. In some embodiments balance refund system 320 may be one or more servers from a serverless or scaling server system. In some embodiments, the balance refund system 320 may further include a peripheral interface, a transceiver, a mobile network interface in communication with the processor 310, a bus configured to facilitate communication between the various components of the balance refund system 320, and a power source configured to power one or more components of the balance refund system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the balance refund system 320 may include one or more storage devices configured to store information used by the processor 310 (or other components) to perform certain functions related to the disclosed embodiments. In one example, the balance refund system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The balance refund system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the balance refund system 320 may include the memory 330 that may include one or more programs 350 to perform one or more functions of the disclosed embodiments. For example, in some embodiments, the balance refund system 320 may additionally manage dialogue and/or other interactions with the customer via a program 350.

The processor 310 may execute one or more programs 350 located remotely from the balance refund system 320. For example, the balance refund system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a balance refund system database 360 for storing related data to enable the balance refund system 320 to perform one or more of the processes and functionalities associated with the disclosed embodiments.

The balance refund system database 360 may include stored data relating to status data (e.g., average session duration data, location data, idle time between sessions, and/or average idle time between sessions) and historical status data. According to some embodiments, the functions provided by the balance refund system database 360 may also be provided by a database that is external to the balance refund system 320, such as the database 416 as shown in FIG. 4.

The balance refund system 320 may also be communicatively connected to one or more memory devices (e.g., databases) locally or through a network. The remote memory devices may be configured to store information and may be accessed and/or managed by the balance refund system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The balance refund system 320 may also include one or more I/O devices 370 that may comprise one or more interfaces for receiving signals or input from devices and providing signals or output to one or more devices that allow data to be received and/or transmitted by the balance refund system 320. For example, the balance refund system 320 may include interface components, which may provide interfaces to one or more input devices, such as one or more keyboards, mouse devices, touch screens, track pads, trackballs, scroll wheels, digital cameras, microphones, sensors, and the like, that enable the balance refund system 320 to receive data from a user (such as, for example, via the user device 402).

In examples of the disclosed technology, the balance refund system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the balance refund system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the balance refund system 320 may include a greater or lesser number of components than those illustrated.

FIG. 4 is a block diagram of an example system that may be used to view and interact with card system 408, according to an example implementation of the disclosed technology. The components and arrangements shown in FIG. 4 are not intended to limit the disclosed embodiments as the components used to implement the disclosed processes and features may vary. As shown, card system 408 may interact with a user device 402 via a network 406. In certain example implementations, the card system 408 may include a local network 412, a balance refund system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the card system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the card system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The balance refund system 320 may include programs (scripts, functions, algorithms) to configure data for visualizations and provide visualizations of datasets and data models on the user device 402. This may include programs to generate graphs and display graphs. The balance refund system 320 may include programs to generate histograms, scatter plots, time series, or the like on the user device 402. This may include graphical user interfaces which can show the balance of an account over time that changes as a result of user transactions or refunds.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The card system 408 may be associated with and optionally controlled by one or more entities such as a business, corporation, individual, partnership, or any other entity that provides one or more of goods, services, and consultations to individuals such as customers. In some embodiments, the card system 408 may be controlled by a third party on behalf of another business, corporation, individual, partnership. The card system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the balance refund system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the card system 408 to interact with one another and to connect to the network 406 for interacting with components in the system 400 environment. In some embodiments, the local network 412 may include an interface for communicating with or linking to the network 406. In other embodiments, certain components of the card system 408 may communicate via the network 406, without a separate local network 406.

The card system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access card system 408 using the cloud computing environment. User device 402 may be able to access card system 408 using specialized software. The cloud computing environment may eliminate the need to install specialized software on user device 402.

In accordance with certain example implementations of the disclosed technology, the card system 408 may include one or more computer systems configured to compile data from a plurality of sources the balance refund system 320, web server 410, and/or the database 416. The balance refund system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Although the preceding description describes various functions of a web server 410, a balance refund system 320, and a database 416, in some embodiments, some or all of these functions may be carried out by a single computing device.

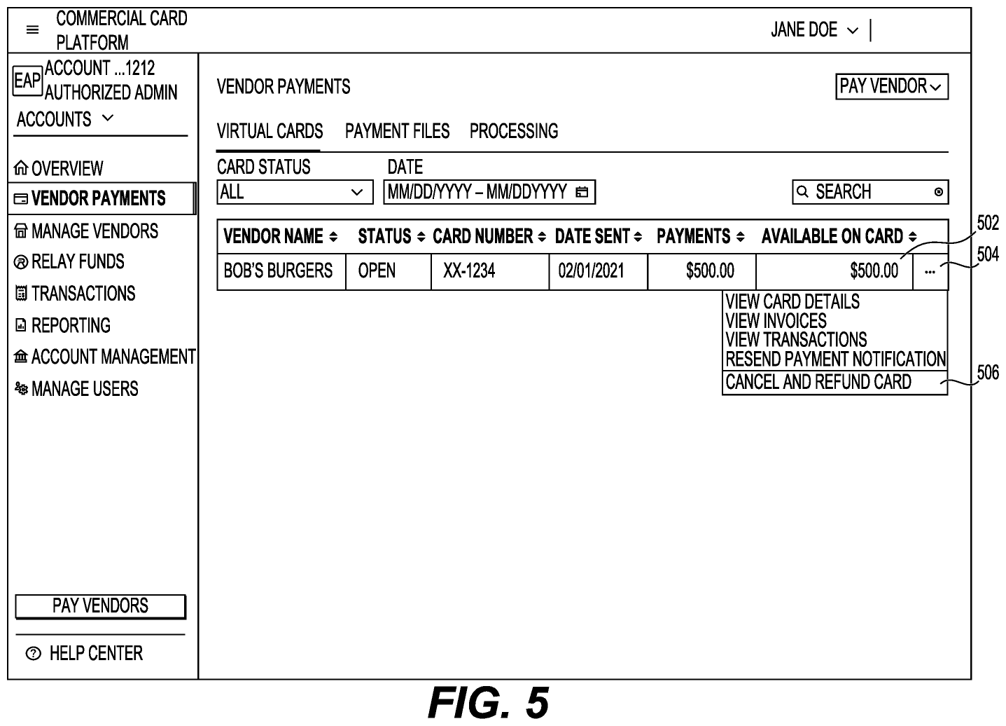

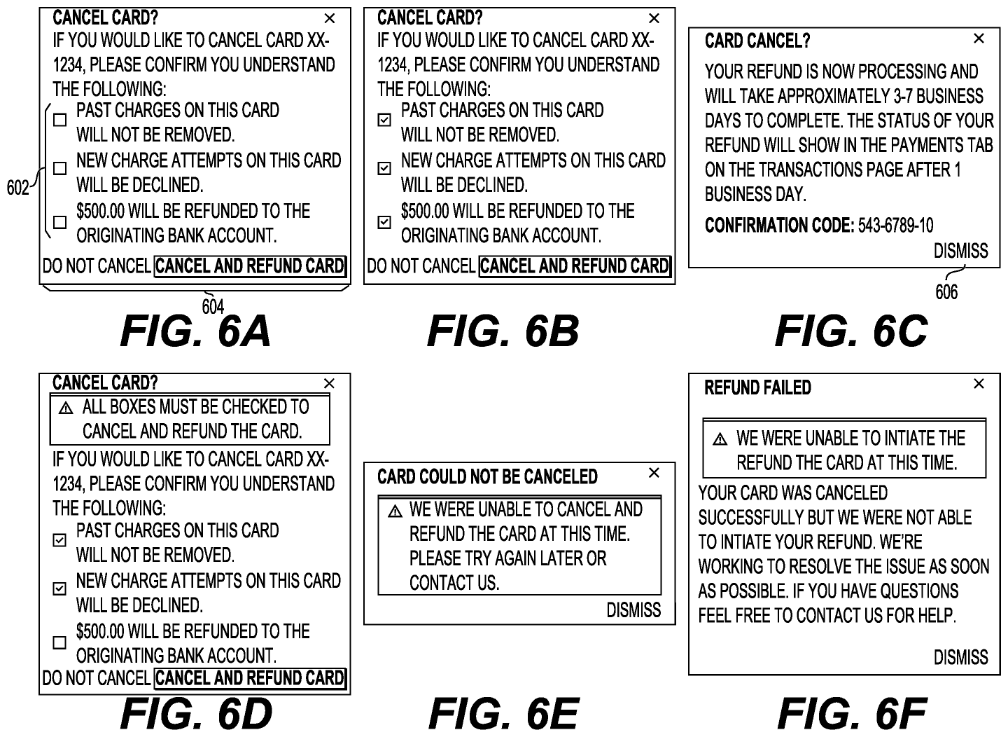

FIGS. 5-8 include example interactive and dynamic graphical user interfaces used to interact with and use balance refund system 320 using a computer or mobile device. FIG. 5 shows an example graphical user interface regarding a specific virtual card (e.g., a prefunded virtual card) used to make a specific payment to a vendor. The graphical user interface shows the status of the card in real time including the amount available on the card (502). The graphical user interface contains a menu (indicated by the ellipsis ( . . . )) (504) which allows a user to select certain actions using an input tool, such as a touchscreen or mouse. Specifically, the user may select, through their computer or mobile device, to cancel or refund the virtual card (506). Selecting that option may cause balance refund system 320 to create an additional graphical user interface, such as one of those found in FIGS. 6A-F.

FIGS. 6A-F includes example graphical user interfaces that may be generated and transmitted to a user device after receiving an indication or signal from a user device that the user would like to cancel the virtual card (FIGS. 6A, 6B, 6D). The graphical user interfaces may include checkboxes (602) requiring the user to confirm they understand information regarding the cancelling the card and starting the refund process (e.g., past charges will not be removed, new charges will be declined, and the balance on the card will be refunded to the original bank account). The graphical user interface may also contain buttons (604) to allow the user to not cancel the virtual card, to cancel and refund the virtual card, or to close the window. In response to the user selecting with their user device to cancel the virtual card, the balance refund system 320 may generate and transmit an updated graphical user interface showing that the card is now canceled (FIG. 6C). This graphical user interface may show the number of days this is expected to take and the confirmation code. This graphical user interface may have an option for the user to dismiss the window using their user device (606). In the event the virtual card could not be cancelled, the balance refund system 320 may generate a graphical user interface telling the user to try again at another time (FIG. 6E). Additionally, in the event the refund failed, but the card was able to be cancelled, the balance refund system 320 may generate a graphical user interface notifying the user of the error (FIG. 6F).

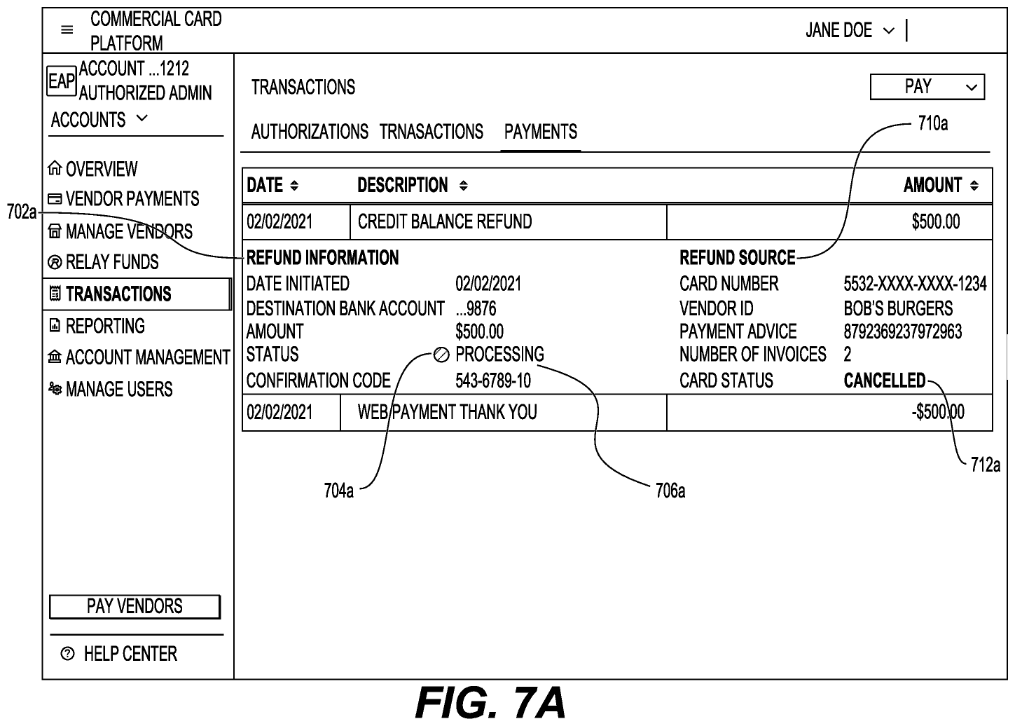

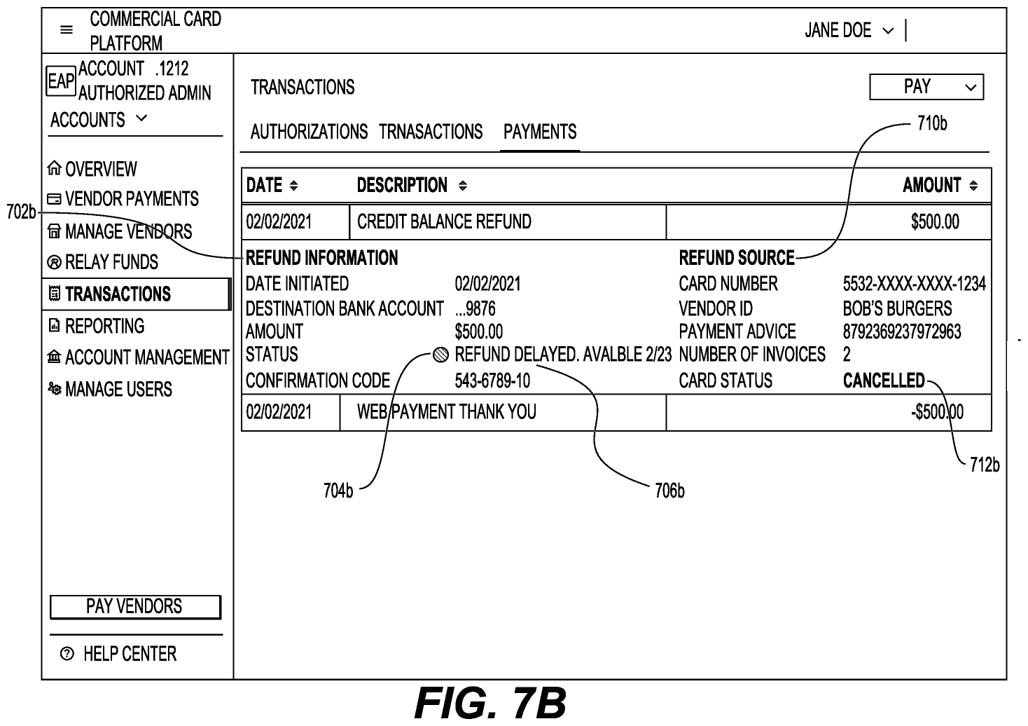

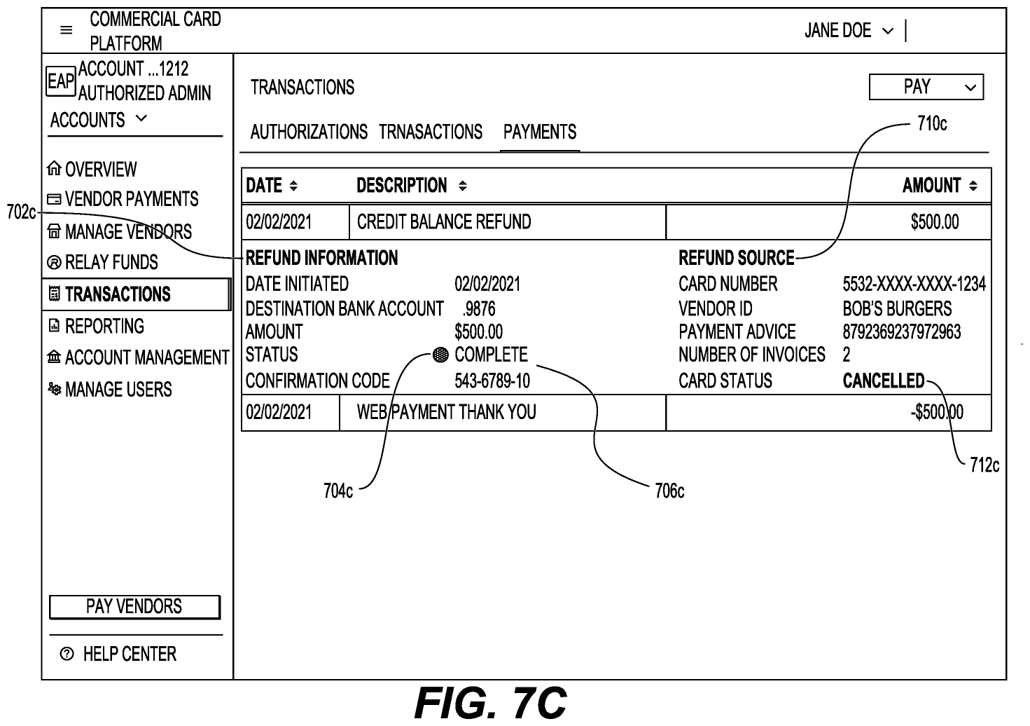

FIGS. 7A-7C show an example credit balance refund status graphical user interface. After the user has canceled the virtual card using their user device (such as shown in FIGS. 6A-6F), the user can check the status of the credit balance refund in real time using the graphical user interface. Information on the graphical user interface may include the amount of the refund or the date initiated. The refund information section of the graphical user interface may show the date the refund was initiated, the destination bank account, the refund status, and the confirmation code. The refund source section (710a) may show the card number of the virtual card being refunded, and other information regarding the card, such as the card status (712a), vendor name, vendor ID, or other information about the payment. The refund status may include a visual indicator (704a) (shown in FIG. 7A with lines sloping upward to the right, but could also be an assortment of different colors, or animations) that changes as the status changes. The refund status also may include a description (706a) (e.g., “processing” or “refund delayed”). The visual indicator and description may be directly related to the generation of the expiration period. Accordingly, FIG. 7A displays an example of the credit balance refund status graphical user interface following a cancellation if there are no unposted transactions and the refund can be processed immediately. FIG. 7B displays an example of the credit balance refund status graphical user interface if there are unposted transactions and an expiration period of 21 days has to be created. The visual indicators (704b) and descriptions (706b) are different between FIGS. 7A and 7B. FIG. 7C displays an example of the credit balance refund status graphical user interface after the refund is complete. The visual indicator (704c) and description (706c) are different to indicate the refund is complete.

The graphical user interface may show all the transactions with refunds in a list order. The user may be able to select, via the graphical user interface, to display only the refunds with a certain refund status (e.g., initiated, failed, or success). The refund status may be actively updated by the balance refund system 320. The user may be able to enter a confirmation code into the graphical user interface and search the refunds for one with a matching confirmation code. The graphical user interface may be able to sort and reorder the list of refunds by date initiated (e.g., from most recent to least recent, or least recent to most recent), refund amount (e.g., from highest amount to lowest amount or lowest amount to highest amount), refund status (e.g., initiated, failed, or success), or other categories. The user may be able select a refund, via the graphical user interface, to see more information about a particular transaction. The graphical user interface may present the additional information as a drop-down menu (e.g., where the list slides or opens to reveal further information about the refund) or as a side panel (e.g., where a panel containing the additional information about the refund enters from the left or right side of the graphical user interface). The user may be able to select a separate part of the graphical user interface to return to the refund list screen.

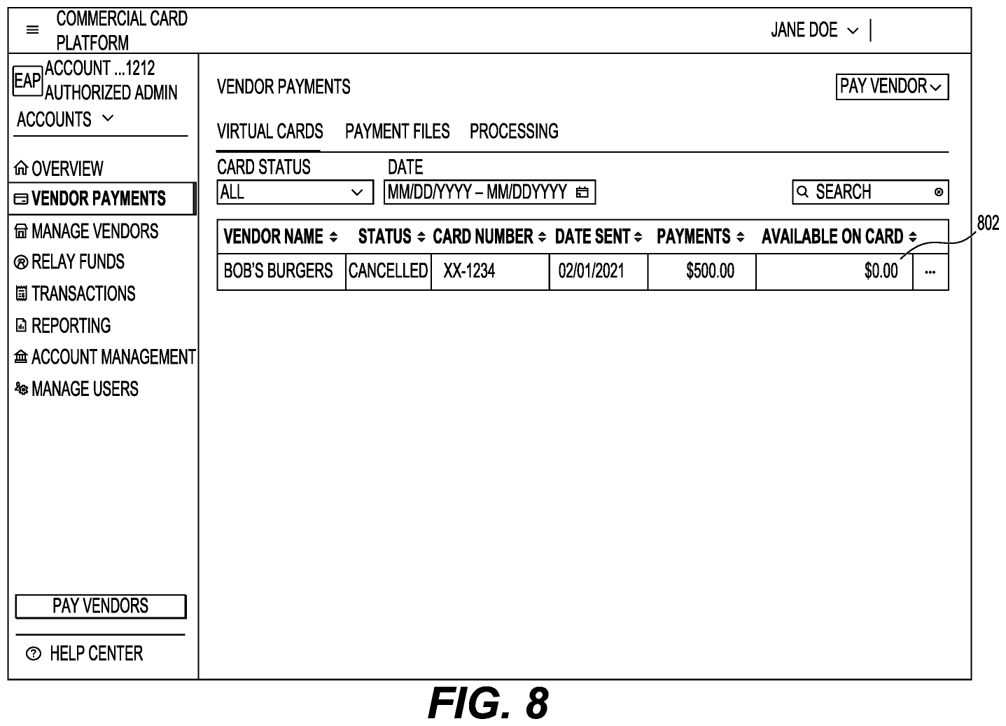

FIG. 8 shows a similar example graphical user interface to that of FIG. 5. FIG. 8 however shows the graphical user interface after the refund has been completed. The balance available on the virtual card (802), as shown in real time, is displayed as $0.00 as a result of the refund, and the status of the virtual card is shown as cancelled.

### Example Use Case

The following example use case describes an example of a typical user flow pattern. This section is intended solely for explanatory purposes and not in limitation.

In one example, Chris' Chicken is a restaurant that uses prefunded virtual cards to pay vendors. Accordingly, Chris opens a prefunded virtual card on January 1 with a $100,000 ACH payment to pay Vendor 1 $25,000, Vendor 2 $50,000, and Vendor 3 $25,000 with the card set to expire on January 31. Chris pays Vendor 1 on January 3^{rd} the full amount. Vendor 2 offers Chris a discount, and charges $45,000 to the card on January 25^{th}. Vendor 3 charges the full amount but doesn't charge the virtual card until January 31^{st}.

On February 1^{st}, the balance refund system 320 receives status information about Chris' prefunded virtual card, including its expiration date, current balance, charges, and total balance. The balance refund system 320 then determines that the card expired on January 31^{st} from the status information. The balance refund system 320 also determines that the card has a balance of $5,000 ($100,000 funding amount minus $95,000 of charges). Chris logs into a mobile application associated with the prefunded virtual card on his cell phone and sees on a graphical user interface that the card is expired and that there is a balance of $5,000. He then selects a button on the mobile application indicating “Refund virtual card balance.” Balance refund system 320 then determines whether the transactions have posted. The charge to Vendor 1 for $25,000 posted several days after the swipe on January 3^{rd}. The charge to Vendor 2 and Vendor 3 have not yet posted. The balance refund system 320 then generates an expiration period for 21 days after the expiration of the card. The graphical user interface on Chris' mobile device updates to show that the refund may be delayed until February 21^{st}.

The Vendor 2 charge posts on February 5^{th}. On February 10^{th}, the charge from Vendor 3 posts. Since the Vendor 3 charge was the last to post, and is before the end of the expiration period, the balance refund system 320 begins to process the refund on February 10^{th}. The graphical user interface on Chris' phone updates on February 10^{th} that the refund is being processed.

In some examples, disclosed systems or methods may involve one or more of the following clauses:

Clause 1: A balance refund system comprising: one or more processors; memory in communication with the one or more processors and storing instructions that are configured to cause the balance refund system to: receive status information regarding a prefunded virtual card; determine, from the status information, that the prefunded virtual card has expired and has a balance; responsive to determining that the prefunded virtual card has expired and has the balance: determine whether the prefunded virtual card is associated with unposted transactions; responsive to determining that the prefunded virtual card is not associated with unposted transactions: refund the balance of the prefunded virtual card to an account; responsive to determining that the prefunded virtual card is associated with unposted transactions: retrieve an expiration period starting from an expiration date of the prefunded virtual card; iteratively determine whether all of the unposted transactions have posted until the expiration period has expired or all the unposted transactions have posted; upon determining that all of the unposted transactions have posted during the expiration period: refund the balance of the prefunded virtual card to the account before expiration of the expiration period; and upon determining the expiration period has expired: refund the balance of the prefunded virtual card to the account after expiration of the expiration period.

Clause 2: The balance refund system of clause 1, wherein the prefunded virtual card is created when funds are debited from the account.

Clause 3: The balance refund system of clause 2, wherein the funds for the prefunded virtual card are debited from the account using an automated clearing house transfer.

Clause 4: The balance refund system of clause 1, wherein the balance of the prefunded virtual card is refunded to the account associated with prefunding the prefunded virtual card.

Clause 5: The balance refund system of clause 1, wherein refunding the balance to the account, refunding the balance of the prefunded virtual card to the account before expiration of the expiration period, or refunding the balance of the prefunded virtual card to the account after expiration of the expiration period further comprises: verifying that a prefunding source for the prefunded virtual card was the account; and responsive to verifying that the prefunding source for the prefunded virtual card was the account: sending the balance of the prefunded virtual card to the account.

Clause 6: The balance refund system of clause 5, wherein the balance of the prefunded virtual card is sent to the account using an automated clearing house transfer.

Clause 7: The balance refund system of clause 1, wherein the memory stores further instructions that are configured to cause the balance refund system to: generate a first graphical user interface displaying the status information, and that the prefunded virtual card has expired and has the balance; and transmit, to a user device, the first graphical user interface for display.

Clause 8: The balance refund system of clause 7, wherein the memory stores further instructions that are configured to cause the balance refund system to: generate, upon the refund of the balance of the prefunded virtual card to the account, a second graphical user interface displaying a first message that the prefunded virtual card is being refunded; and transmit, to the user device, the second graphical user interface for display.

Clause 9: The balance refund system of clause 7, wherein the memory stores further instructions that are configured to cause the balance refund system to: generate, upon generating the expiration period, a third graphical user interface displaying a second message that the refund may be delayed; and transmit, to the user device, the third graphical user interface for display.

Clause 10: The balance refund system of clause 9, wherein the second message displays an estimated time for the refund based on a length of the expiration period.

Clause 11: The balance refund system of clause 1, wherein the expiration period varies based on the status information of the prefunded virtual card.

Clause 12: The balance refund system of clause 1, wherein the expiration period is 21 days.

Clause 13: A balance refund system comprising: one or more processors; memory in communication with the one or more processors and storing instructions that are configured to cause the balance refund system to: receive status information regarding a prefunded virtual card; receive a cancellation request associated with the prefunded virtual card; determine, from the status information and the cancelation request, that the prefunded virtual card has been cancelled and has a balance; generate a first graphical user interface displaying a first message that the prefunded virtual card is cancelled and giving a user an option to request a refund; transmit the first graphical user interface to a user device for display; receive, from the first graphical user interface on the user device, a request for the refund of the balance of the prefunded virtual card; determine whether an initial transfer has cleared; responsive to determining that the initial transfer has cleared: refund the balance of the prefunded virtual card to an account; responsive to determining that the initial transfer has not cleared: generate a second graphical user interface displaying a second message that the refund may be delayed; transmit the second graphical user interface to the user device for display; and upon the clearing of the initial transfer, refund the balance of the prefunded virtual card to the account.

Clause 14: The balance refund system of clause 13, wherein the balance of the prefunded virtual card is refunded to the account associated with prefunding the prefunded virtual card.

Clause 15: The balance refund system of clause 13, wherein refunding the balance to the account further comprises: verifying that a prefunding source for the prefunded virtual card was the account; and responsive to verifying that the prefunding source for the prefunded virtual card was the account: sending the balance of the prefunded virtual card to the account.

Clause 16: The balance refund system of clause 15, wherein the balance of the prefunded virtual card is sent to the account using an automated clearing house transfer.

Clause 17: The balance refund system of clause 13, wherein the initial transfer is an automated clearing house transfer.

Clause 18: The balance refund system of clause 13, wherein the memory stores further instructions that are configured to cause the balance refund system to: generate, upon the refund of the balance of the prefunded virtual card to the account, a third graphical user interface displaying a status identifier of the prefunded virtual card as refunded; and transmit, to the user device, the third graphical user interface for display.

Clause 19: A balance refund system comprising: one or more processors; memory in communication with the one or more processors and storing instructions that are configured to cause the balance refund system to: receive status information regarding a prefunded virtual card; determine, from the status information, that the prefunded virtual card has expired and has a balance; generate a first graphical user interface displaying the status information, and that the prefunded virtual card has expired and has the balance; transmit, to a user device, the first graphical user interface for display; responsive to determining that the prefunded virtual card has expired and has the balance: determine whether the prefunded virtual card is associated with unposted transactions; responsive to determining that the prefunded virtual card is not associated with unposted transactions: refund the balance of the prefunded virtual card to an account; generate a second graphical user interface displaying a first message that the prefunded virtual card is being refunded; transmit, to the user device, the second graphical user interface for display; responsive to determining that the prefunded virtual card is associated with unposted transactions: retrieve an expiration period starting from an expiration date of the prefunded virtual card; iteratively determine whether all of the unposted transactions have posted until the expiration period has expired or all the unposted transactions have posted; upon determining that all of the unposted transactions have posted during the expiration period: refund the balance of the prefunded virtual card to the account before expiration of the expiration period; upon determining the expiration period has expired: refund the balance of the prefunded virtual card to the account after expiration of the expiration period; generate a third graphical user interface displaying the first message that the prefunded virtual card is being refunded; and transmit, to the user device, the third graphical user interface for display.

Clause 20: The balance refund system of clause 19, wherein refunding the balance to the account, refunding the balance of the prefunded virtual card to the account before expiration of the expiration period, or refunding the balance of the prefunded virtual card to the account after expiration of the expiration period further comprises: verifying that a prefunding source for the prefunded virtual card was the account; and responsive to verifying that the prefunding source for the prefunded virtual card was the account: sending the balance of the prefunded virtual card to the account.

Clause 21: A balance refund system comprising: one or more processors; memory in communication with the one or more processors and storing instructions that are configured to cause the balance refund system to: receive status information regarding a prefunded virtual card; receive a cancellation request associated with the prefunded virtual card; determine, from the status information and the cancelation request, that the prefunded virtual card has been cancelled and has a balance; generate a first graphical user interface displaying a first message that the prefunded virtual card is cancelled and indicating the balance is being refunded to the account; transmit the first graphical user interface to a user device for display; determine whether an initial transfer has cleared; responsive to determining that the initial transfer has cleared: refund the balance of the prefunded virtual card to an account; responsive to determining that the initial transfer has not cleared: generate a second graphical user interface displaying a second message that the refund may be delayed; transmit the second graphical user interface to the user device for display; and upon the clearing of the initial transfer, refund the balance of the prefunded virtual card to the account.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A balance refund system comprising:
one or more processors;
memory in communication with the one or more processors and storing instructions that are configured to cause the balance refund system to:
receive status information regarding a prefunded virtual card;
determine, from the status information, that the prefunded virtual card has expired and has a balance;
responsive to determining that the prefunded virtual card has expired and has the balance:
determine whether the prefunded virtual card is associated with unposted transactions;
responsive to determining that the prefunded virtual card is not associated with unposted transactions:
refund the balance of the prefunded virtual card to an account;
responsive to determining that the prefunded virtual card is associated with unposted transactions:
retrieve an expiration period starting from an expiration date of the prefunded virtual card;
iteratively determine whether all of the unposted transactions have posted until the expiration period has expired or all the unposted transactions have posted;
upon determining that all of the unposted transactions have posted during the expiration period:
refund the balance of the prefunded virtual card to the account before expiration of the expiration period; and
upon determining the expiration period has expired:
refund the balance of the prefunded virtual card to the account after expiration of the expiration period.

2. The balance refund system of claim 1, wherein the prefunded virtual card is created when funds are debited from the account.

3. The balance refund system of claim 2, wherein the funds for the prefunded virtual card are debited from the account using an automated clearing house transfer.

4. The balance refund system of claim 1, wherein the balance of the prefunded virtual card is refunded to the account associated with prefunding the prefunded virtual card.

5. The balance refund system of claim 1, wherein refunding the balance to the account, refunding the balance of the prefunded virtual card to the account before expiration of the expiration period, or refunding the balance of the prefunded virtual card to the account after expiration of the expiration period further comprises:
verifying that a prefunding source for the prefunded virtual card was the account; and
responsive to verifying that the prefunding source for the prefunded virtual card was the account:
sending the balance of the prefunded virtual card to the account.

6. The balance refund system of claim 5, wherein the balance of the prefunded virtual card is sent to the account using an automated clearing house transfer.

7. The balance refund system of claim 1, wherein the memory stores further instructions that are configured to cause the balance refund system to:
generate a first graphical user interface displaying the status information, and that the prefunded virtual card has expired and has the balance; and
transmit, to a user device, the first graphical user interface for display.

8. The balance refund system of claim 7, wherein the memory stores further instructions that are configured to cause the balance refund system to:
generate, upon the refund of the balance of the prefunded virtual card to the account, a second graphical user interface displaying a first message that the prefunded virtual card is being refunded; and
transmit, to the user device, the second graphical user interface for display.

9. The balance refund system of claim 7, wherein the memory stores further instructions that are configured to cause the balance refund system to:
generate, upon generating the expiration period, a third graphical user interface displaying a second message that the refund may be delayed; and
transmit, to the user device, the third graphical user interface for display.

10. The balance refund system of claim 9, wherein the second message displays an estimated time for the refund based on a length of the expiration period.

11. The balance refund system of claim 1, wherein the expiration period varies based on the status information of the prefunded virtual card.

12. The balance refund system of claim 1, wherein the expiration period is 21 days.

13. A balance refund system comprising:
one or more processors;
memory in communication with the one or more processors and storing instructions that are configured to cause the balance refund system to:
receive status information regarding a prefunded virtual card;
receive a cancellation request associated with the prefunded virtual card;
determine, from the status information and the cancelation request, that the prefunded virtual card has been cancelled and has a balance;
generate a first graphical user interface displaying a first message that the prefunded virtual card is cancelled and indicating the balance is being refunded to the account;
transmit the first graphical user interface to a user device for display;
determine whether an initial transfer has cleared;
responsive to determining that the initial transfer has cleared:
refund the balance of the prefunded virtual card to an account;
responsive to determining that the initial transfer has not cleared:
generate a second graphical user interface displaying a second message that the refund may be delayed;
transmit the second graphical user interface to the user device for display; and
upon the clearing of the initial transfer, refund the balance of the prefunded virtual card to the account.

14. The balance refund system of claim 13, wherein the balance of the prefunded virtual card is refunded to the account associated with prefunding the prefunded virtual card.

15. The balance refund system of claim 13, wherein refunding the balance to the account further comprises:
verifying that a prefunding source for the prefunded virtual card was the account; and
responsive to verifying that the prefunding source for the prefunded virtual card was the account:
sending the balance of the prefunded virtual card to the account.

16. The balance refund system of claim 15, wherein the balance of the prefunded virtual card is sent to the account using an automated clearing house transfer.

17. The balance refund system of claim 13, wherein the initial transfer is an automated clearing house transfer.

18. The balance refund system of claim 13, wherein the memory stores further instructions that are configured to cause the balance refund system to:
generate, upon the refund of the balance of the prefunded virtual card to the account, a third graphical user interface displaying a status identifier of the prefunded virtual card as refunded; and
transmit, to the user device, the third graphical user interface for display.

19. A balance refund system comprising:
one or more processors;
memory in communication with the one or more processors and storing instructions that are configured to cause the balance refund system to:
receive status information regarding a prefunded virtual card;
determine, from the status information, that the prefunded virtual card has expired and has a balance;
generate a first graphical user interface displaying the status information, and that the prefunded virtual card has expired and has the balance;
transmit, to a user device, the first graphical user interface for display;
responsive to determining that the prefunded virtual card has expired and has the balance:
determine whether the prefunded virtual card is associated with unposted transactions;
responsive to determining that the prefunded virtual card is not associated with unposted transactions:
refund the balance of the prefunded virtual card to an account;
generate a second graphical user interface displaying a first message that the prefunded virtual card is being refunded;
transmit, to the user device, the second graphical user interface for display;
responsive to determining that the prefunded virtual card is associated with unposted transactions:
retrieve an expiration period starting from an expiration date of the prefunded virtual card;
iteratively determine whether all of the unposted transactions have posted until the expiration period has expired or all the unposted transactions have posted;
upon determining that all of the unposted transactions have posted during the expiration period:
refund the balance of the prefunded virtual card to the account before expiration of the expiration period;
upon determining the expiration period has expired:
refund the balance of the prefunded virtual card to the account after expiration of the expiration period;
generate a third graphical user interface displaying the first message that the prefunded virtual card is being refunded; and
transmit, to the user device, the third graphical user interface for display.

20. The balance refund system of claim 19, wherein refunding the balance to the account, refunding the balance of the prefunded virtual card to the account before expiration of the expiration period, or refunding the balance of the prefunded virtual card to the account after expiration of the expiration period further comprises:
verifying that a prefunding source for the prefunded virtual card was the account; and
responsive to verifying that the prefunding source for the prefunded virtual card was the account:
sending the balance of the prefunded virtual card to the account.
